(19) United States
(12) Patent Application Publication
(10) Pub. No.: US 2025/0321024 A1
(43) Pub. Date: Oct. 16, 2025

(54) SYSTEM AND METHOD FOR DETERMINING HEAT DEMAND OF A HYDRONIC HEATING SYSTEM

(71) Applicant: Laars Heating Systems Company, Rochester, NH (US)

(72) Inventors: Lou Vorsteveld, Derry, NH (US); Steven Hunting, Rollinsford, NH (US)

(73) Assignee: Laars Heating Systems Company, Rochester, NH (US)

(21) Appl. No.: 18/869,344

(22) PCT Filed: May 31, 2023
(86) PCT No.: PCT/US2023/024012

§ 371 Date: Nov. 26, 2024

Related U.S. Application Data
(60) Provisional application No. 63/347,660, filed on Jun. 1, 2022.

(51) Int. Cl. F24H 15/355; F24D 3/02; F24D 3/08; F24D 19/10; F24H 15/215; F24H 15/219; F24H 15/31; F24H 15/40; G05D 23/19

(52) U.S. Cl. CPC F24H 15/355; F24D 3/02; F24D 3/08; F24D 19/1009; F24H 15/215; F24H 15/219; F24H 15/31; F24H 15/40; G05D 23/19

(57) ABSTRACT

A water heating system configured to activate a pump such that the water flows between a boiler and a hydronic heating system. When a heat source is firing at a preexisting firing rate, the system maintains firing the heat source at the preexisting firing rate for a time period, and measures temperatures of water at a boiler water inlet and at a boiler water outlet. When the heat source is not firing, the system prevents firing the heat source for a time period, and measures temperatures of water at the boiler water inlet and at the boiler water outlet. The system calculates temperature differences between the measured temperatures at different times during the time period, and controls the heat source to provide heat to the boiler heat exchanger at a firing rate determined based on a comparison between the temperature differences.

### CROSS REFERENCE TO RELATED APPLICATIONS

This application claims priority from U.S. Provisional Application Ser. No. 63/347,660, titled SYSTEM AND METHOD FOR DETERMINING HEAT DEMAND OF A HYDRONIC HEATING SYSTEM, filed Jun. 1, 2022, incorporated herein by reference in its entirety for all purposes.

### FIELD OF THE INVENTION

This disclosure relates to a system and method for determining heat demand of a hydronic heating system.

### BACKGROUND OF THE INVENTION

A conventional hydronic heater system includes a boiler and one or more space heat zones with radiators plumbed to the boiler inlet/outlet. During a heat demand from the space heater zones, water flowing through the heat exchanger of the boiler is heated by the boiler heat source (e.g. gas burner) and is pumped through the radiators of the space heat zones via piping. In conventional hydronic water heater systems, the boiler controller fires the boiler at a firing rate that typically exceeds the heat demand of the space heater zones, thereby resulting in wasted fuel.

### SUMMARY OF THE INVENTION

A water heating system comprising a boiler including a boiler water inlet fluidly connected to a boiler water outlet via a boiler heat exchanger internal to the boiler, a heat source providing heat to the boiler heat exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a controller, upon receiving a demand for hydronic heat from the hydronic heating system, is configured to activate a pump such that the water flows between the boiler heat exchanger and the hydronic heating system, when the heat source is firing at a preexisting firing rate, maintain firing the heat source at the preexisting firing rate for a time period, and during the time period measuring temperatures of water at the boiler water inlet and at the boiler water outlet, when the heat source is not firing, prevent firing the heat source for a time period, and during the time period measuring temperatures of water at the boiler water inlet and at the boiler water outlet, calculate temperature differences between the measured temperatures at different times during the time period, and control the heat source to provide heat to the boiler heat exchanger at a firing rate determined based on a comparison between the temperature differences.

A water heating system comprising a boiler including a boiler water inlet fluidly connected to a boiler water outlet via a boiler heat exchanger internal to the boiler, a heat source providing heat to the boiler heat exchanger, a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for domestic hot water heat from the storage tank, is configured to activate a pump such that the water flows between the boiler heat exchanger and the storage tank heat exchanger, perform PID control by firing the heat source at a PID firing rate based on measured temperatures of water at the boiler water inlet and at the boiler water outlet, upon receiving a demand for hydronic heat from the hydronic heating system, activate a valve supplying water from the boiler heat exchanger to the hydronic heating system and maintain the PID firing rate for a time period, and during the time period, measuring temperatures of water at the boiler water inlet and at the boiler water outlet, calculate temperature differences in the measured temperatures at different times during the time period, and control the heat source to provide heat to the boiler heat exchanger at a firing rate determined based on a comparison between the temperature differences in the measured temperatures.

A method for controlling a water heating system including a boiler including a boiler water inlet fluidly connected to a boiler water outlet via a boiler heat exchanger internal to the boiler, a heat source providing heat to the boiler heat exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for hydronic heat from the hydronic heating system. The method includes activating, by the boiler controller, a pump such that the water flows between the boiler heat exchanger and the hydronic heating system, when the heat source is firing at a preexisting firing rate, maintaining, by the boiler controller, firing the heat source at the preexisting firing rate for a time period, and during the time period measuring temperatures of water at the boiler water inlet and at the boiler water outlet, when the heat source is not firing, preventing, by the boiler controller, firing the heat source for a time period, and during the time period measuring temperatures of water at the boiler water inlet and at the boiler water outlet, calculating, by the boiler controller, temperature differences at different times during the time period between the measured temperatures, and controlling, by the boiler controller, the heat source to provide heat to the boiler heat exchanger at a firing rate determined based on a comparison between the temperature differences.

A method for controlling a water heating system including a boiler including a boiler water inlet fluidly connected to a boiler water outlet via a boiler heat exchanger internal to the boiler, a heat source providing heat to the boiler heat exchanger, a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for domestic hot water heat from the storage tank. The method includes activating, by the controller, a pump such that the water flows between the boiler heat exchanger and the storage tank heat exchanger, performing, by the controller, PID control by firing the heat source at a PID firing rate based on measured temperatures of water at the boiler water inlet and at the boiler water outlet, upon receiving a demand for hydronic heat from the hydronic heating system, activating, by the controller, a valve supplying water from the boiler heat exchanger to the hydronic heating system and maintain the PID firing rate for a time period, and during the time period, measuring temperatures of water at the boiler water inlet and at the boiler water outlet, calculating, by the controller, temperature differences in the measured temperatures at different times during the time period, and controlling, by the controller, the heat source to provide heat to the boiler heat exchanger at a firing rate determined based on a comparison between the temperature differences in the measured temperatures.

### BRIEF DESCRIPTION OF THE DRAWINGS

The drawing figures depict one or more implementations, by way of example only, not by way of limitation. In the figures, like reference numerals refer to the same or similar elements.

FIG. 1 is a block diagram of an embodiment of a plumbing configuration of hydronic heater system according to an aspect of the disclosure.

FIG. 2 is block diagram of an embodiment of an electrical configuration of a hydronic heater system according to an aspect of the disclosure.

FIG. 3 is a flowchart describing an operation of an embodiment of a hydronic heater system according to an aspect of the disclosure.

FIG. 4 is a more detailed flowchart describing a more detailed operation of the embodiment of the hydronic heater system in FIG. 3 according to an aspect of the disclosure.

FIG. 5 is a flowchart describing an operation of an embodiment of a hydronic heater system according to an aspect of the disclosure.

FIG. 6 is a more detailed flowchart describing a more detailed operation of the embodiment of the hydronic heater system in FIG. 5 according to an aspect of the disclosure.

### DETAILED DESCRIPTION OF EMBODIMENTS OF THE INVENTION

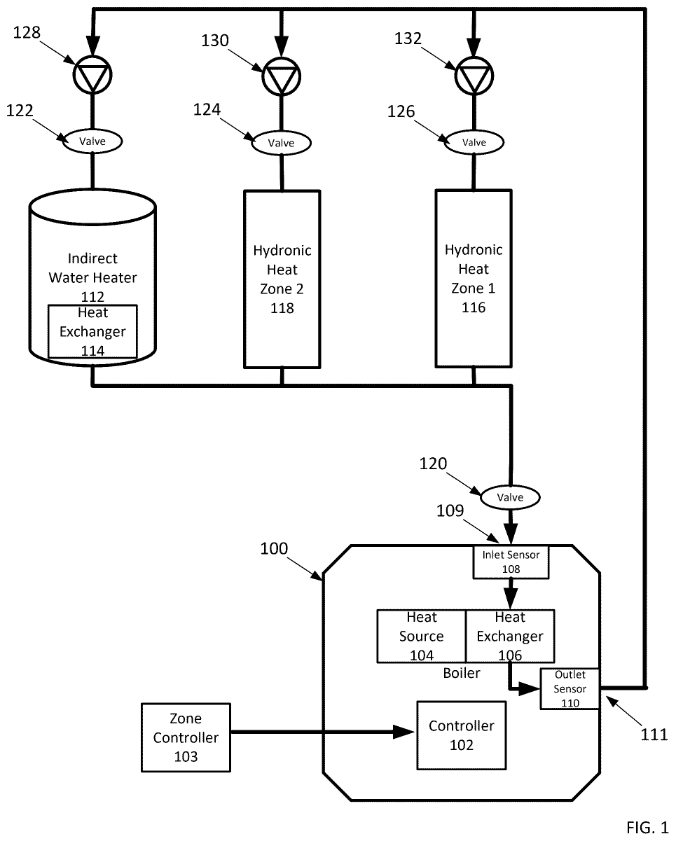

FIG. 1 is a block diagram of an embodiment of a plumbing configuration of hydronic heater system. Included in the system is boiler 100 and hydronic space heat radiators in one or more space heat zones 116 and 118 that are plumbed together. In addition to space heat zones 116 and 118, other heater appliances such as indirect water heater 112 supplying hot water, herein referred to as domestic hot water (DHW) may also be plumbed with the boiler. Space heating calls may be controlled in conjunction with an outdoor sensor (not show) which establishes a relationship between outdoor temp and boiler water temp. During operation, boiler 100 is triggered to produce hot water in response to a heat demand signal received from zone controller 103 which is connected to respective thermostats (not shown) and connected to zone pumps of space heat zone 116 and/or space heat zone 118. The indirect hot water heater is controlled by either an aquastat or DHW sensor and pump 128, that are all connected to boiler controller 102. Boiler controller 102 may have 2 electrical contacts: 1 for space heating and 1 for DHW via various temperature sensing devices (e.g. sensors, thermostats, aquastats, etc.). Upon being triggered by zone controller 103, boiler controller 102 controls heat source 104 (e.g. gas burner, electric element, etc.) to fire and heat water in heat exchanger 106. In the case of a gas burner, a valve may release the gas, at which point a burner fan (not shown) applies positive air pressure to the system to suck an amount of gas from the valve that is proportional the burner fan speed (e.g. if the firing rate is high, then the fan speed will be high and the amount of gas sucked out and ignited will be high thereby producing high heat for the boiler; if the firing rate is low, then the fan speed will be low and the amount of gas sucked out and ignited will be low thereby producing low heat for the boiler). During this procedure, zone controller 103 also controls one or more of pumps 130 and/or 132 to start pumping heated water from boiler outlet 111 through the system appliances and back to boiler inlet 109. Valves 120, 124 and 126 may also be controlled by zone controller 103, or they may be manual valves that are normally open. For example, if a heat demand is received from space heat zone 116, boiler controller 102 fires heat source 104 and zone controller 103 turns on pump 132 to force hot water from the boiler heat exchanger 106 to radiators (not shown) in space heat zone 116. Likewise, if a heat demand is received from space heat zone 118, boiler controller 102 fires heat source 104 and zone controller 103 turns on pump 130 to force hot water from the boiler heat exchanger 106 to radiators (not shown) in space heat zone 118. In yet another example, if a heat demand is received from indirect water heater 112, boiler controller 102 fires heat source 104 and boiler controller 102 turns on pump 128 to force hot water from the boiler heat exchanger 106 to heat exchanger 114 of indirect water heater 112. In either case, once the heat demands are satisfied, boiler controller 102 is able to reduce or turn off the firing rate of heat source 104 independently, or in response to a shutoff command from zone controller 103.

Generally, boiler 100 supplies hot water to indirect water heater 112, space heat zone 116 and space heat zone 118 either one at a time or simultaneously by controlling the firing rate of the heat source 104 and the operational state of pumps 130-132 with the aid of zone controller 103. Firing rate generally dictates the amount of heat produced by heat source 104 (e.g. gas flow volume for a gas burner, electrical current flowing through an electric heater element, etc.). This may be measured in percentage of a maximum amount of heat or the maximum firing rate (e.g. British Thermal Units (BTUs)) that can be produced from heat source 104 (e.g. 0%-100%).

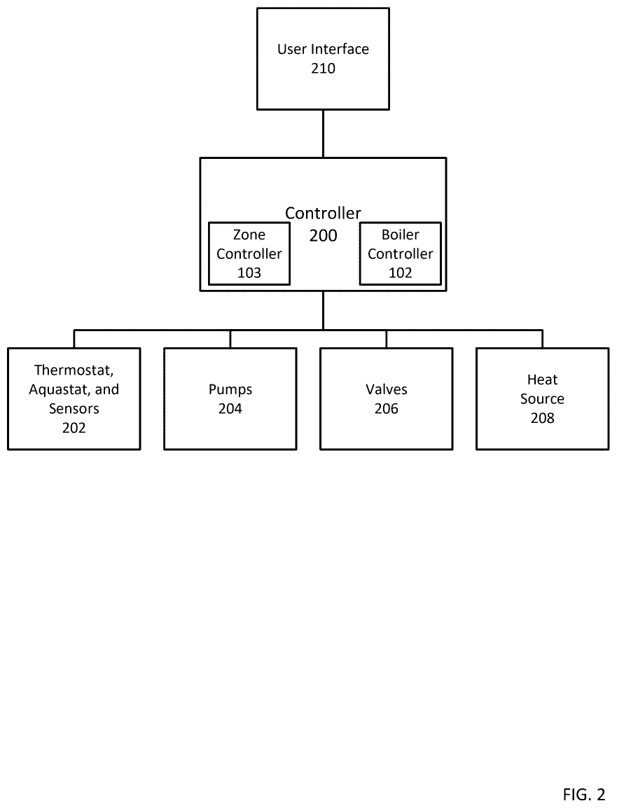

FIG. 2 is block diagram of an embodiment of an electrical configuration of the hydronic heater system shown in FIG. 1. In general, controller 200, which includes a separate or a combined boiler controller 102 and zone controller 103 may include a processor and other supporting electronic devices such as memory, input/output ports, etc., may be connected to various electrical devices (e.g. pumps, thermostats, etc.) for supporting the control of the hydronic heater system shown in FIG. 1. For example, controller 200 may be electrically connected via electrical wires to thermostats and sensors 202 (e.g. aquastat/DHW sensor (thermostat) of the indirect water heater, thermostats of the space heat zones, inlet/outlet temperature/flow sensors of the boiler, etc.), pumps 204, water valves 206, heat source 208 and user interface 210. These electrical connections allow controller 200 to receive/send electrical signals to/from the various electrical devices in the system.

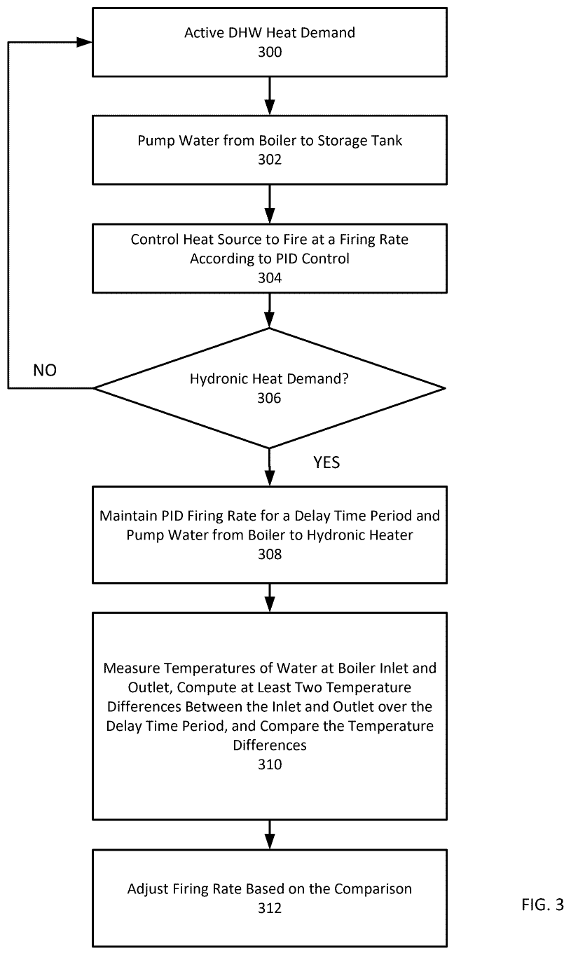

FIG. 3 is a flowchart describing an operation of an embodiment of a hydronic heater system where there is an active DHW demand followed by a hydronic heat demand also referred to as zone heat (ZH) demand. In step 300 there is an active DHW heat demand received from the thermostat (e.g. aquastat or DHW temperature sensor) of indirect water heater 112. In response to this DHW heat demand, boiler controller 102 pumps water from boiler inlet 111 to heat exchanger 114 of indirect water heater 112 in step 302, and boiler controller 102 controls the boiler to fire at a firing rate according to proportional-integral-derivative (PID) control in step 304 based on detected temperatures of the water at the boiler inlet/outlet. In step 306, if zone controller 103 has not received a hydronic heat demand from the thermostats of the hydronic heat zones 116 and/or 118, the boiler controller 102 continues PID control until the DHW heat demand is satisfied (e.g. the thermostat of indirect water heater 112 indicates that the tank water has reached the desired temperature).

It is noted that using a temperature sensor for DHW sensing allows the system to develop an DHW anticipated tank temp feature whereby the burner shuts off before the tank reaches set point. In this scenario, the pump will continue to operate for a short time to purge excess heat from the boiler into the tank. This is beneficial on milder days to lower boiler temp and reduce standby losses. This process could be optimized to minimize burner operation and maximize purge time to a reasonable extent).

If, however, in step 306, boiler controller 102 has received a hydronic heat demand from the thermostats of the hydronic heat zones 116 and/or 118 via zone controller 103, the PID control is frozen in its present state in step 308 such that the firing rate is maintained constant while pumps 130 and/or 132 are turned on by zone controller 103 to pump water through hydronic heat zones 116 and/or 118. The firing rate and inlet/outlet water temperatures measured by sensors 108/110 at the time the PID control is frozen are captured in what is referred to herein as a “snapshot” during a zone heat (ZH) load anticipation mode. More specifically, the PID control is frozen for a period of time referred to herein as a “delay period” during which the boiler water is pumped through the hydronic heat zones 116 and/or 118 at the frozen firing rate. At one or more other times during the delay period, in step 310, boiler controller 102 takes an additional snapshot of the inlet/outlet water temperatures. Boiler controller 102 then computes a first temperature difference between the inlet/outlet water temperatures from the first snapshot (i.e. inlet/outlet temperature differential at Time1), and computes at least a second temperature difference between the inlet/outlet water temperatures from the second snapshot (i.e. inlet/outlet temperature differential at Time2). The first and second temperature differences are then compared in step 310.

Then, in step 312, boiler controller 102 uses the comparison to adjust the firing rate to a more appropriate level. For example, if the temperature difference reduced from the first snapshot to the second snapshot by more than a predetermined threshold during the delay period, then boiler controller 102 determines that the hydronic heat demand is high (e.g. zone is large with many radiators expelling the hydronic heat) and increases the firing rate from the original PID firing rate by a large amount (e.g. increase from 30% to 60%). If, however, the temperature difference reduced from the first snapshot to the second snapshot by less than a predetermined threshold during the delay period, then boiler controller 102 determines that the hydronic heat demand is low (e.g. zone is small with few radiators expelling the hydronic heat) and increases the firing rate from the original PID firing rate, but by a smaller amount (e.g. increase from 15% to 20%). This ensures that the DHW heat demand and the hydronic heat demand are adequately and simultaneously met without over firing the boiler to a rate that is wasteful (e.g. the firing rate is increased proportional to the determined amount of heat demand).

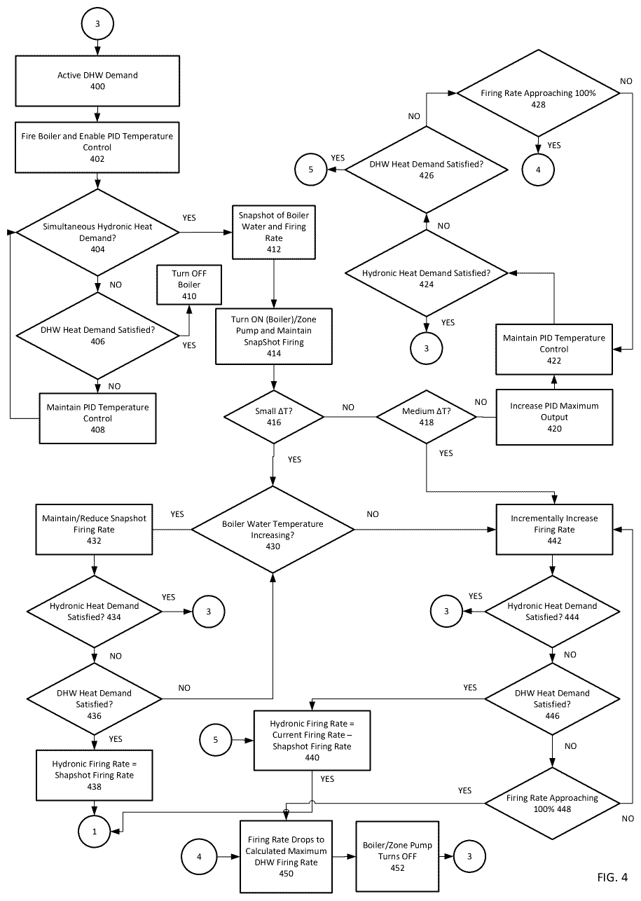

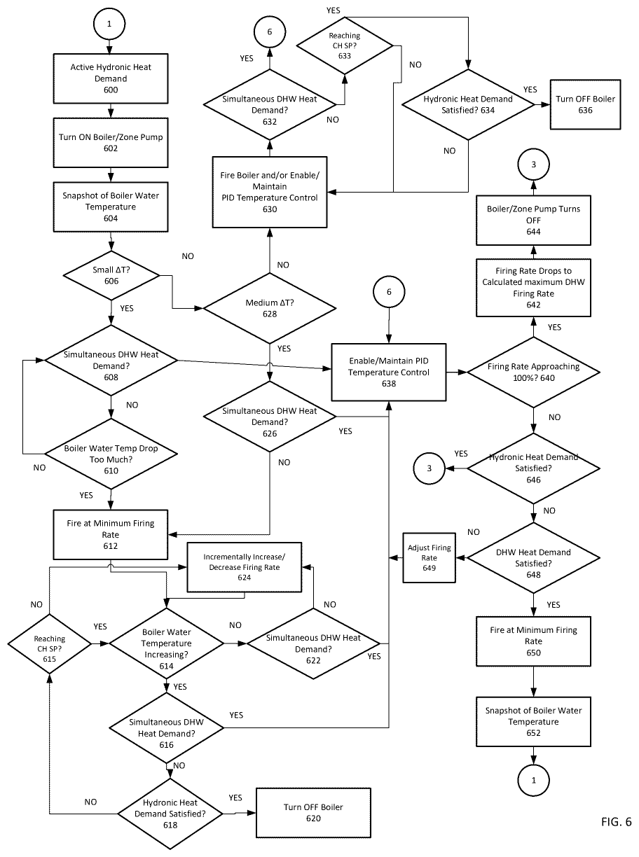

FIG. 4 is a more detailed flowchart describing the operation of an embodiment of the hydronic heater system in FIG. 3. Before describing FIG. 4, it is worth noting that the flowcharts in FIG. 4 and FIG. 6 (which is described later in the document) are connected via states 1-6. These states include state 1: ZH demand only, state 3: DHW demand only, state 4: Combined DHW+ZH demand approaching 100% firing rate, before DHW priority, state 5: ZH demand only: process of maintaining SnapShot firing, and state 6: Combined DHW+ZH demand (<100% firing rate).

In step 400 an active HDW heat demand is received when in state 3 (DHW demand only), and in step 402, boiler controller 102 performs PID control to meet the heat demand. In step 404, if a hydronic heat demand is not received, then step 406 determines if the DHW heat demand is satisfied or not. If the DHW heat demand is satisfied, then boiler controller 102 turns off the boiler in step 410. If the DHW heat demand is not satisfied, then boiler controller 102 continues to perform PID control.

If, however, in step 404, simultaneous hydronic heat demand is received from hydronic heat zones 116 and/or 118, then boiler controller 102 takes a snapshot of the boiler inlet/outlet water temperatures and the firing rate in step 412. In step 414, boiler controller 102 maintains the snapshot firing rate and begins pumping water to hydronic heat zones 116 and/or 118 for a delay period via zone controller 103. Temperature differences between at least two snapshots are compared in a ZH load anticipation test mode.

If in step 416 the temperature difference is small, then the boiler water is monitored to determine if it is increasing in step 430. If the boiler water is increasing, then the snapshot firing rate is maintained or reduced slightly in step 432. If the hydronic heat demand is satisfied in step 434, the algorithm moves to state 3 in the flowchart to maintain the original PID temperature control from the DHW demand. If the hydronic heat demand is not satisfied in step 434, it is determined if the DHW heat demand is satisfied in step 436. If the DHW heat demand is not satisfied, then the control continues to determine if boiler water temperature is increasing. If the DHW heat demand is satisfied, then the control computes the hydronic firing rate as being equal to the snapshot firing rate in step 438 and moves to state 1 in the flowchart.

If, however, in step 416 the temperature difference is not small, then boiler controller 102 determines if the temperature difference is medium in step 418. If the temperature difference is not medium, then the PID maximum output is set in step 420 and the PID control is maintained in step 422. In step 424, if the hydronic heat demand is satisfied, then the algorithm moves to state 3 in the flowchart to maintain the original PID control for the DHW heat demand. In step 424, if the hydronic heat demand is not satisfied, then it is determined if the DHW heat demand is satisfied in step 426. If the DHW heat demand is satisfied, then the algorithm moves to state 5 in the flowchart. If the DHW heat demand is not satisfied, then it is determined in step 428 if the firing rate is approaching 100%. If the firing rate is approaching 100%, then the algorithm moves to state 4 in the flowchart. At this point the controller may lock out the space heat zones so that the firing rate can be dropped to Max DHW firing rate (e.g. space heat is too much load and is therefore shut down in order to focus on satisfying DHW demand).

If the temperature difference is medium in step 418, however, then the firing rate is incrementally increased in step 442. If the hydronic heat demand is satisfied in step 444, then the algorithm moves to state 3 in the flowchart. If the hydronic heat demand is not satisfied in step 444, then it is determined if the DHW heat demand is satisfied or not in step 446. If the DHW heat demand is satisfied, then the hydronic firing rate is set equal to the current firing rate minus the snapshot firing rate in step 440. If the DHW heat demand is not satisfied, then it is determined if the firing rate is gradually approaching 100% in step 448. If the firing rate is approaching 100% in step 448, then the controller decreases the firing rate to a calculated maximum DHW firing rate in step 450 and turns off the zone pumps in step 452 by locking out zone controller 103 before moving to state 3 in the flowchart. This effectively provides a method for smart space heating without load dependent DHW priority.

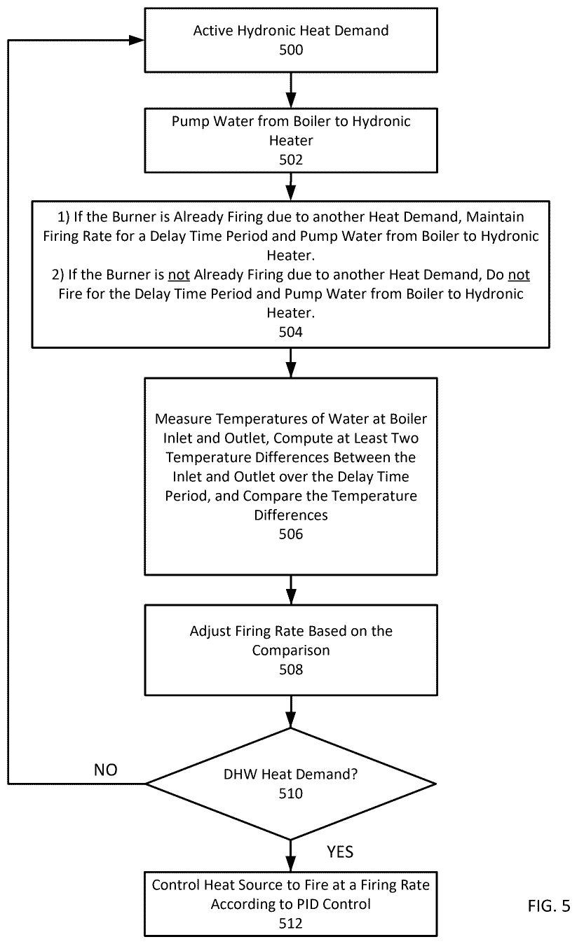

FIG. 5 is a flowchart describing an operation of an embodiment of a hydronic heater system where there is an active hydronic heat demand followed by a DHW heat demand. In step 500, there is an active hydronic heat demand received from the thermostat of hydronic heat zones 116 and/or 118. In response to this hydronic heat demand, zone controller 103 pumps water from the boiler to the radiators of hydronic heat zones 116 and/or 118 in step 502, and boiler controller 102 controls the boiler to maintain the current firing rate (0%-100%) in step 504 (e.g. firing rate is frozen). For example, if the boiler is already firing (e.g. at 50%) due to another heat demand, boiler controller 102 maintains the firing rate (e.g. at 50%) and begins pumping water to hydronic heat zones 116 and/or 118. Similarly, if the boiler is not firing at that time (e.g. boiler is currently off), boiler controller 102 maintains the boiler in the off state (e.g. firing at 0%) and zone controller 103 begins pumping water to hydronic heat zones 116 and/or 118. It is noted that the boiler controller 102 does not directly know that another zone is calling for ZH demand. However, boiler controller 102 detects an increase in demand due to lower inlet temperatures over time. Conversely, once one of several space heating zones are satisfied and shut off by the zone controller 103, the boiler will “infer” this because the inlet temperatures will start to increase.

In step 506, boiler controller 102 captures the firing rate and inlet/outlet water temperatures at the time the firing rate is frozen in a “snapshot” (e.g. ZH load anticipation mode). The firing rate is frozen for a “delay period” during which the boiler water is pumped to hydronic heat zones 116 and/or 118 at the frozen firing rate. At one or more other times during the delay period, in step 506, boiler controller 102 takes an additional snapshot of the inlet/outlet water temperatures.

Boiler controller 102 then computes a first temperature difference between the inlet/outlet water temperatures from the first snapshot (e.g. temperature differential between inlet/outlet at the first snapshot), and computes at least a second temperature difference between the inlet/outlet water temperatures from the second snapshot (e.g. temperature differential between inlet/outlet at the second snapshot). The first and second temperature differences are then compared in step 506. Then, in step 508, boiler controller 102 uses the comparison to adjust the firing rate to a more appropriate level. For example, if the temperature difference reduced from the first snapshot to the second snapshot by more than a predetermined threshold during the delay period, then boiler controller 102 determines that the hydronic heat demand is high (e.g. zone is large with many radiators expelling heat into the zones) and increases the firing rate from the original firing rate by a large amount (e.g. increase from 30% to 60%). If, however, the temperature difference reduced from the first snapshot to the second snapshot by less than a predetermined threshold during the delay period, then boiler controller 102 determines that the hydronic heat demand is low (e.g. zone is small with few radiators expelling heat into the zones) and increases the firing rate from the original firing rate, but by a smaller amount (e.g. increase from 30% to 40%). This ensures that the original heat demand and the hydronic heat demand are adequately met without over firing the boiler to a rate that is wasteful (e.g. the firing rate is increased proportional to the determined amount of heat demand). If, in step 510, boiler controller 102 does not receive a DHW heat demand, the process is repeated upon receiving another hydronic heat demand. If, however, in step 510, boiler controller 102 receives a DHW heat demand, boiler controller 102 controls the burner to fire at a rate according to PID control. Essentially, boiler controller 102 switches from the adjusted firing rate to the PID firing rate to ensure that the DHW heat demand is satisfied as quickly as possible for the comfort of the end user.

FIG. 6 is a more detailed flowchart describing the operation of an embodiment of the hydronic heater system in FIG. 5. In step 600 there is an active hydronic heat demand received from the thermostat of hydronic heat zones 116 and/or 118. In response to this hydronic heat demand, zone controller 103 pumps water from the boiler to the radiators of hydronic heat zones 116 and/or 118 in step 602, and boiler controller 102 controls the boiler to maintain the current firing rate (0%-100%) in step 604 (e.g. firing rate is frozen) during a delay period to capture at least two snapshots of the boiler water temperatures from the inlet and outlet at different times during the delay period. Temperature differences between at least two snapshots are compared. If in step 606 the temperature difference is small, it is then determined if simultaneous DHW heat demand is received in step 608.

If a simultaneous DHW heat demand is received, PID temperature control is enabled/maintained in step 638 and it is determined in step 640 if the firing rate is approaching 100% or not. If the firing rate is approaching 100%, then boiler controller 102 decreases the firing in step 642 and zone controller 103 turns off the boiler pumps in step 644 and proceeds to state 3 in the flowchart. If the firing rate is not approaching 100%, then it is determined if hydronic heat demand is satisfied in step 646. If the hydronic heat demand is satisfied, then the algorithm proceeds to state 3 in the flowchart. If the hydronic heat demand is not satisfied, then it is determined if DHW heat demand is satisfied in step 648. If the DHW heat demand is satisfied, then the firing rate is set at the minimum firing rate in step 650, a snapshot of the inlet/outlet temperatures are captured in step 652 and the algorithm proceeds to state 1 in the flowchart. If the DHW heat demand is not satisfied, then firing rate is adjusted in step 649 and PID temperature control is enabled/maintained in step 638.

If a simultaneous DHW heat demand is not received in step 608, it is determined if the boiler water temperature has dropped below a threshold in step 610. If the boiler water temperature does drop below the threshold, then boiler controller 102 fires the boiler at a minimum firing rate in step 612 and determines if the boiler water temperature is increasing in step 614.

If the boiler water temperature is not increasing, then it is determined if simultaneous DHW heat demand is received in step 622. If simultaneous DHW heat demand is received, then PID temperature control is enabled/maintained. If simultaneous DHW heat demand is not received, then boiler controller 102 incrementally increases the firing rate 624. If the temperature exceed the ZH setpoint, then in step 624 the firing rate is adjusted downward.

If the boiler water temperature is increasing, then it is determined if simultaneous DHW heat demand is received in step 616. If simultaneous DHW heat demand is received, then PID temperature control is enabled/maintained. If simultaneous DHW heat demand is not received, then it is determined if hydronic heat demand is satisfied in step 618. If hydronic heat demand is satisfied, then the boiler is turned off in step 620. If hydronic heat demand is not satisfied, then then boiler controller 102 determines if the temperature is reaching the ZH setpoint. If the temperature is reaching the ZH setpoint, then the controller repeats step 614. However, if the temperature is not reaching the ZH setpoint, then the controller incrementally increases the firing rate in step 624. If the temperature is exceeding ZH setpoint, then go to step 624 and decrease the firing rate.

If, however, in step 606 the temperature difference is not small, it is then determined the temperature difference is medium in step 628. If the temperature difference is medium, then it is determined if simultaneous DHW heat demand is received in step 626. If the temperature difference is not medium, then the boiler controller 102 fires the boiler and enables/maintains PID temperature control in step 630, and determines if a simultaneous DHW heat demand has been received in step 632. If a simultaneous DHW heat demand has been received, then the algorithm moves to state 6 in the flowchart. If a simultaneous DHW heat demand has not been received, it is determined if the temperature is reaching the ZH setpoint. If the temperature is not reaching the ZH setpoint, the controller repeats step 630. However, if the temperature is reaching the ZH setpoint, then the controller determines if hydronic heat demand is satisfied in step 634. If hydronic heat demand is satisfied, then the boiler is turned off in step 636. If hydronic heat demand is not satisfied, then the boiler controller 102 enables/maintains PID temperature control.

In either of the scenarios shown in FIGS. 3-6 boiler controller 102 takes snapshots of the inlet/outlet temperatures at different times during a delay period while maintaining a constant firing rate (e.g. 0%-100%). A comparison of the temperature differential between the inlet/outlet temperatures at the different times during the delay period indicate the hydronic heat demand. For example, if the temperature differential is small at the first snapshot, but is large at the second snapshot, then the heat demand is determined to be large and the firing rate should be increased by a large amount. However, if the temperature differential is small at the first snapshot, and is still relatively small at the second snapshot, then the heat demand is determined to be small and the firing rate should be increased by a smaller amount or burner start-up should continue to be delayed until a finite time has been reached. Essentially, the firing rate is adjusted proportional to the temperature differentials.

It is noted that rather than turning the boiler off immediately upon reaching satisfaction of heat demand (e.g. upon reaching the setpoint temperature of the DHW tank or the zone), the boiler controller gradually begins reducing the firing rate as DHW/Zone satisfaction is reached/approached. In one example, when the DHW/Zone tank has a temperature sensor (not shown), the temperature sensor can be monitored. When the temperature sensor indicates that the DHW/Zone temperature is approaching setpoint, then the firing rate begins to ramp down such that when setpoint is reached, the system is nearing shutdown. In another example, when the DHW/Zone does not have a temperature sensor, but rather relies on an aquastat/thermostat respectively, the boiler controller can determine that the DHW/Zone temperature is approaching setpoint when the inlet/outlet temperature differences begin to approach convergence, at which point the firing rate then begins to gradually ramp down such that when setpoint is reached, the system is nearing shutdown.

It will be understood that the terms and expressions used herein have the ordinary meaning as is accorded to such terms and expressions with respect to their corresponding respective areas of inquiry and study except where specific meanings have otherwise been set forth herein. For example, the term “coupled” as used herein refers to any logical, optical, physical or electrical connection, link or the like by which signals or light produced or supplied by one system element are imparted to another coupled element. Unless described otherwise, coupled elements or devices are not necessarily directly coupled or connected to one another and may be separated by intermediate components, elements or communication media that may modify, manipulate or carry the signals. Also, the term “coupled” can refer to direct or indirect mechanical or thermal connectedness. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount. The term “substantially” as used herein means the parameter value or the like

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

In the above detailed description, numerous specific details were set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The invention includes, but is not limited to, the following aspects:
1. A water heating system comprising:
   a boiler including a boiler water inlet fluidly connected to a boiler water outlet via a boiler heat exchanger internal to the boiler;
   a heat source providing heat to the boiler heat exchanger;
   a hydronic heating system including a hydronic heating water inlet fluidly connected to the boiler water outlet, and a hydronic heating water outlet fluidly connected to the boiler water inlet, such that water flows between the boiler heat exchanger and the hydronic heating system; and
   a controller, upon receiving a demand for hydronic heat from the hydronic heating system, configured to:
      activate a pump such that the water flows between the boiler heat exchanger and the hydronic heating system,
      when the heat source is firing at a preexisting firing rate, maintain firing the heat source at the preexisting firing rate for a time period, and during the time period measuring temperatures of water at the boiler water inlet and at the boiler water outlet,
      when the heat source is not firing, prevent firing the heat source for a time period, and during the time period measuring temperatures of water at the boiler water inlet and at the boiler water outlet,
      calculate temperature differences between the measured temperatures at different times during the time period, and
      control the heat source to provide heat to the boiler heat exchanger at a firing rate determined based on a comparison between the temperature differences.
2. The water heating system of aspect 1,
   wherein the controller is further configured to determine the firing rate in proportion to the comparison of the temperature differences.
3. The water heating system of aspect 1,
   wherein the controller is further configured to:
      continue to calculate the comparison of the temperature differences in the measured temperatures after the heat source is providing heat, and
      incrementally increase the firing rate when the comparison of the temperature differences in the measured temperatures is greater than a threshold.
4. The water heating system of aspect 1,
   wherein the controller is further configured to calculate the comparison of the temperature differences over the time period by taking a snapshot of the measured temperatures at a first time when the pump is activated, and comparing the snapshot to the measured temperatures at a second time during the time period.
5. The water heating system of aspect 1, further comprising:
   a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger,
   wherein upon receiving a demand for domestic hot water heat from the storage tank, the controller is further configured to:
      open a valve to provide water from the boiler heat exchanger to the storage tank heat exchanger, and
      perform PID control based on the measured temperatures and increase the firing rate based on the PID control.
6. A water heating system comprising:
   a boiler including a boiler water inlet fluidly connected to a boiler water outlet via a boiler heat exchanger internal to the boiler;
   a heat source providing heat to the boiler heat exchanger;
   a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger;
   a hydronic heating system including a hydronic heating water inlet fluidly connected to the boiler water outlet, and a hydronic heating water outlet fluidly connected to the boiler water inlet, such that water flows between the boiler heat exchanger and the hydronic heating system; and
   a boiler controller, upon receiving a demand for domestic hot water heat from the storage tank, configured to:
      activate a pump such that the water flows between the boiler heat exchanger and the storage tank heat exchanger,
      perform PID control by firing the heat source at a PID firing rate based on measured temperatures of water at the boiler water inlet and at the boiler water outlet,
      upon receiving a demand for hydronic heat from the hydronic heating system, activate a valve supplying water from the boiler heat exchanger to the hydronic heating system and maintain the PID firing rate for a time period, and during the time period, measuring temperatures of water at the boiler water inlet and at the boiler water outlet,
      calculate temperature differences in the measured temperatures at different times during the time period, and
      control the heat source to provide heat to the boiler heat exchanger at a firing rate determined based on a comparison between the temperature differences in the measured temperatures.
7. The water heating system of aspect 1,
   wherein the controller is further configured to determine the firing rate in proportion to the comparison of the temperature differences in the measured temperatures.
8. The water heating system of aspect 1,
   wherein the controller is further configured to:
      continue to calculate the comparison of the temperature differences in the measured temperatures after the heat source is providing heat, and incrementally increase the firing rate when the comparison of the temperature differences in the measured temperatures is greater than a threshold.
9. The water heating system of aspect 1,
   wherein the controller is further configured to calculate the comparison of the temperature differences in the measured temperatures over the time period by taking a snapshot of the measured temperatures at a first time when the valve is activated, and comparing the snapshot to the measured temperatures at a second time during the time period.
10. The water heating system of aspect 1,
   wherein upon the demand for domestic hot water heat from the storage tank being satisfied, or upon the demand for hydronic heat from the hydronic heating system being satisfied, the controller is further configured to reduce the firing rate.
11. A method for controlling a water heating system including a boiler including a boiler water inlet fluidly connected to a boiler water outlet via a boiler heat exchanger internal to the boiler, a heat source providing heat to the boiler heat exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for hydronic heat from the hydronic heating system, the method comprising:
   activating, by the boiler controller, a pump such that the water flows between the boiler heat exchanger and the hydronic heating system,
   when the heat source is firing at a preexisting firing rate, maintaining, by the boiler controller, firing the heat source at the preexisting firing rate for a time period, and during the time period measuring temperatures of water at the boiler water inlet and at the boiler water outlet,
   when the heat source is not firing, preventing, by the boiler controller, firing the heat source for a time period, and during the time period measuring temperatures of water at the boiler water inlet and at the boiler water outlet,
   calculating, by the boiler controller, temperature differences at different times during the time period between the measured temperatures, and
   controlling, by the boiler controller, the heat source to provide heat to the boiler heat exchanger at a firing rate determined based on a comparison between the temperature differences.
12. The method for controlling a water heating system of aspect 11, further comprising:
   determining, by the controller, the firing rate in proportion to the comparison of the temperature differences.
13. The method for controlling a water heating system of aspect 11, further comprising:
   continuing, by the boiler controller, to calculate the comparison of the temperature differences in the measured temperatures after the heat source is providing heat, and
   incrementally increasing, by the boiler controller, the firing rate when the comparison of the temperature differences in the measured temperatures is greater than a threshold.
14. The method for controlling a water heating system of aspect 11, further comprising:
   calculating, by the controller, the comparison of the temperature differences in the measured temperatures over the time period by taking a snapshot of the measured temperatures at a first time when the pump is activated, and comparing, by the controller, the snapshot to the measured temperatures at a second time during the time period.
15. The method for controlling a water heating system of aspect 11, the system including a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, the method further comprising:
   upon receiving a demand for domestic hot water heat from the storage tank:
      opening, by the controller, a valve to provide water from the boiler heat exchanger to the storage tank heat exchanger, and
      performing, by the controller, PID control based on the measured temperatures and increase the firing rate based on the PID control.
16. A method for controlling a water heating system including a boiler including a boiler water inlet fluidly connected to a boiler water outlet via a boiler heat exchanger internal to the boiler, a heat source providing heat to the boiler heat exchanger, a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for domestic hot water heat from the storage tank, the method comprising:
   activating, by the controller, a pump such that the water flows between the boiler heat exchanger and the storage tank heat exchanger,
   performing, by the controller, PID control by firing the heat source at a PID firing rate based on measured temperatures of water at the boiler water inlet and at the boiler water outlet,
   upon receiving a demand for hydronic heat from the hydronic heating system, activating, by the controller, a valve supplying water from the boiler heat exchanger to the hydronic heating system and maintain the PID firing rate for a time period, and during the time period, measuring temperatures of water at the boiler water inlet and at the boiler water outlet,
   calculating, by the controller, temperature differences in the measured temperatures at different times during the time period, and
   controlling, by the controller, the heat source to provide heat to the boiler heat exchanger at a firing rate determined based on a comparison between the temperature differences in the measured temperatures.
17. The method for controlling a water heating system of aspect 11, further comprising:
   determining, by the controller, the firing rate in proportion to the comparison of the temperature differences in the measured temperatures.
18. The method for controlling a water heating system of aspect 11, further comprising: continuing to calculate, by the controller, the comparison of the temperature differences in the measured temperatures after the heat source is providing heat, and incrementally increasing, by the controller, the firing rate when the comparison of the temperature differences in the measured temperatures is greater than a threshold.
19. The method for controlling a water heating system of aspect 11, further comprising:
   calculating, by the controller, the comparison of the temperature differences in the measured temperatures over the time period by taking a snapshot of the measured temperatures at a first time when the valve is activated, and comparing, by the controller, the snapshot to the measured temperatures at a second time during the time period.
   20. The method for controlling a water heating system of aspect 11, further comprising:
   wherein upon the demand for domestic hot water heat from the storage tank being satisfied, or upon the demand for hydronic heat from the hydronic heating system being satisfied, reducing, by the controller, the firing rate.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed:

1. A water heating system comprising:
a boiler including a boiler water inlet fluidly connected to a boiler water outlet via a boiler heat exchanger internal to the boiler;
a heat source providing heat to the boiler heat exchanger;
a hydronic heating system including a hydronic heating water inlet fluidly connected to the boiler water outlet, and a hydronic heating water outlet fluidly connected to the boiler water inlet, such that water flows between the boiler heat exchanger and the hydronic heating system; and
a controller, upon receiving a demand for hydronic heat from the hydronic heating system, configured to:
activate a pump such that the water flows between the boiler heat exchanger and the hydronic heating system,
when the heat source is firing at a preexisting firing rate, maintain firing the heat source at the preexisting firing rate for a time period, and
during the time period measuring temperatures of water at the boiler water inlet and at the boiler water outlet,
when the heat source is not firing, prevent firing the heat source for a time period, and during the time period measuring temperatures of water at the boiler water inlet and at the boiler water outlet,
calculate temperature differences between the measured temperatures at different times during the time period, and
control the heat source to provide heat to the boiler heat exchanger at a firing rate determined based on a comparison between the temperature differences.

2. The water heating system of claim 1,
wherein the controller is further configured to determine the firing rate in proportion to the comparison of the temperature differences.

3. The water heating system of claim 1,
wherein the controller is further configured to:
continue to calculate the comparison of the temperature differences in the measured temperatures after the heat source is providing heat, and
incrementally increase the firing rate when the comparison of the temperature differences in the measured temperatures is greater than a threshold.

4. The water heating system of claim 1,
wherein the controller is further configured to calculate the comparison of the temperature differences over the time period by taking a snapshot of the measured temperatures at a first time when the pump is activated, and comparing the snapshot to the measured temperatures at a second time during the time period.

5. The water heating system of claim 1, further comprising:
a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger,
wherein upon receiving a demand for domestic hot water heat from the storage tank, the controller is further configured to:
open a valve to provide water from the boiler heat exchanger to the storage tank heat exchanger, and
perform PID control based on the measured temperatures and increase the firing rate based on the PID control.

6. A water heating system comprising:
a boiler including a boiler water inlet fluidly connected to a boiler water outlet via a boiler heat exchanger internal to the boiler;
a heat source providing heat to the boiler heat exchanger;
a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger;
a hydronic heating system including a hydronic heating water inlet fluidly connected to the boiler water outlet, and a hydronic heating water outlet fluidly connected to the boiler water inlet, such that water flows between the boiler heat exchanger and the hydronic heating system; and
a boiler controller, upon receiving a demand for domestic hot water heat from the storage tank, configured to:
activate a pump such that the water flows between the boiler heat exchanger and the storage tank heat exchanger,
perform PID control by firing the heat source at a PID firing rate based on measured temperatures of water at the boiler water inlet and at the boiler water outlet,
upon receiving a demand for hydronic heat from the hydronic heating system, activate a valve supplying water from the boiler heat exchanger to the hydronic heating system and maintain the PID firing rate for a time period, and during the time period, measuring temperatures of water at the boiler water inlet and at the boiler water outlet,
calculate temperature differences in the measured temperatures at different times during the time period, and
control the heat source to provide heat to the boiler heat exchanger at a firing rate determined based on a comparison between the temperature differences in the measured temperatures.

7. The water heating system of claim 1,
wherein the controller is further configured to determine the firing rate in proportion to the comparison of the temperature differences in the measured temperatures.

8. The water heating system of claim 1,
wherein the controller is further configured to:
continue to calculate the comparison of the temperature differences in the measured temperatures after the heat source is providing heat, and
incrementally increase the firing rate when the comparison of the temperature differences in the measured temperatures is greater than a threshold.

9. The water heating system of claim 1,
wherein the controller is further configured to calculate the comparison of the temperature differences in the measured temperatures over the time period by taking a snapshot of the measured temperatures at a first time when the valve is activated, and comparing the snapshot to the measured temperatures at a second time during the time period.

10. The water heating system of claim 1,
wherein upon the demand for domestic hot water heat from the storage tank being satisfied, or upon the demand for hydronic heat from the hydronic heating system being satisfied, the controller is further configured to reduce the firing rate.

11. A method for controlling a water heating system including a boiler including a boiler water inlet fluidly connected to a boiler water outlet via a boiler heat exchanger internal to the boiler, a heat source providing heat to the boiler heat exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for hydronic heat from the hydronic heating system, the method comprising:
activating, by the boiler controller, a pump such that the water flows between the boiler heat exchanger and the hydronic heating system,
when the heat source is firing at a preexisting firing rate, maintaining, by the boiler controller, firing the heat source at the preexisting firing rate for a time period, and during the time period measuring temperatures of water at the boiler water inlet and at the boiler water outlet,
when the heat source is not firing, preventing, by the boiler controller, firing the heat source for a time period, and during the time period measuring temperatures of water at the boiler water inlet and at the boiler water outlet,
calculating, by the boiler controller, temperature differences at different times during the time period between the measured temperatures, and
controlling, by the boiler controller, the heat source to provide heat to the boiler heat exchanger at a firing rate determined based on a comparison between the temperature differences.

12. The method for controlling a water heating system of claim 11, further comprising:
determining, by the controller, the firing rate in proportion to the comparison of the temperature differences.

13. The method for controlling a water heating system of claim 11, further comprising:
continuing, by the boiler controller, to calculate the comparison of the temperature differences in the measured temperatures after the heat source is providing heat, and
incrementally increasing, by the boiler controller, the firing rate when the comparison of the temperature differences in the measured temperatures is greater than a threshold.

14. The method for controlling a water heating system of claim 11, further comprising:
calculating, by the controller, the comparison of the temperature differences in the measured temperatures over the time period by taking a snapshot of the measured temperatures at a first time when the pump is activated, and comparing, by the controller, the snapshot to the measured temperatures at a second time during the time period.

15. The method for controlling a water heating system of claim 11, the system including a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, the method further comprising:
upon receiving a demand for domestic hot water heat from the storage tank:
opening, by the controller, a valve to provide water from the boiler heat exchanger to the storage tank heat exchanger, and
performing, by the controller, PID control based on the measured temperatures and increase the firing rate based on the PID control.

16. A method for controlling a water heating system including a boiler including a boiler water inlet fluidly connected to a boiler water outlet via a boiler heat exchanger internal to the boiler, a heat source providing heat to the boiler heat exchanger, a storage tank separate from the boiler for storing water for the water heating system, the storage tank including a storage tank water inlet fluidly connected to a storage tank water outlet via a storage tank heat exchanger internal to the storage tank, wherein the boiler water outlet is fluidly connected to the storage tank water inlet, and the storage tank water outlet is fluidly connected to the boiler water inlet, such that water flows between the boiler heat exchanger and the storage tank exchanger, a hydronic heating system including a hydronic heating water inlet fluidly connected to the boiler water outlet, and a hydronic heating water outlet fluidly connected to the boiler water inlet, such that water flows between the boiler heat exchanger and the hydronic heating system, and a boiler controller, upon receiving a demand for domestic hot water heat from the storage tank, the method comprising:
activating, by the controller, a pump such that the water flows between the boiler heat exchanger and the storage tank heat exchanger,
performing, by the controller, PID control by firing the heat source at a PID firing rate based on measured temperatures of water at the boiler water inlet and at the boiler water outlet,
upon receiving a demand for hydronic heat from the hydronic heating system, activating, by the controller, a valve supplying water from the boiler heat exchanger to the hydronic heating system and maintain the PID firing rate for a time period, and during the time period, measuring temperatures of water at the boiler water inlet and at the boiler water outlet,
calculating, by the controller, temperature differences in the measured temperatures at different times during the time period, and
controlling, by the controller, the heat source to provide heat to the boiler heat exchanger at a firing rate determined based on a comparison between the temperature differences in the measured temperatures.

17. The method for controlling a water heating system of claim 11, further comprising:
determining, by the controller, the firing rate in proportion to the comparison of the temperature differences in the measured temperatures.

18. The method for controlling a water heating system of claim 11, further comprising:
continuing to calculate, by the controller, the comparison of the temperature differences in the measured temperatures after the heat source is providing heat, and
incrementally increasing, by the controller, the firing rate when the comparison of the temperature differences in the measured temperatures is greater than a threshold.

19. The method for controlling a water heating system of claim 11, further comprising:
calculating, by the controller, the comparison of the temperature differences in the measured temperatures over the time period by taking a snapshot of the measured temperatures at a first time when the valve is activated, and comparing, by the controller, the snapshot to the measured temperatures at a second time during the time period.

20. The method for controlling a water heating system of claim 11, further comprising:
wherein upon the demand for domestic hot water heat from the storage tank being satisfied, or upon the demand for hydronic heat from the hydronic heating system being satisfied, reducing, by the controller, the firing rate.
